(19) United States
(12) Patent Application Publication
(10) Pub. No.: US 2025/0236151 A1
(43) Pub. Date: Jul. 24, 2025

(54) DEVICE FOR ADJUSTING THE STIFFNESS OF A SUSPENSION SPRING

(71) Applicant: RENAULT S.A.S., Boulogne Billancourt (FR)

(72) Inventors: Bertrand LEFEBVRE, Courtaboeuf (FR); Laurent MATEOS, Courtaboeuf (FR)

(73) Assignee: RENAULT S.A.S., Boulogne Billancourt (FR)

(21) Appl. No.: 18/698,374

(22) PCT Filed: Sep. 28, 2022
(86) PCT No.: PCT/EP2022/077068

§ 371 Date: Apr. 4, 2024

(30) Foreign Application Priority Data
Oct. 13, 2021 (FR) FR2110840

(51) Int. Cl. B60G 17/02; B60G 15/06; F16F 1/12

(52) U.S. Cl. CPC B60G 17/021; B60G 15/063; F16F 1/121; B60G 2202/12; B60G 2204/1242; B60G 2204/4604

(57) ABSTRACT

A device for adjusting the stiffness of a suspension spring includes a locking sleeve which defines a helical slot for accepting one end of the suspension spring, and an adjusting ring mounted with the ability to rotate relative to the locking sleeve about a main axis. The adjusting ring has a finger which emerges into the helical slot and is able to form an end stop for the end of the suspension spring. Structure is provided for locking the rotational mobility of the adjusting ring relative to the locking sleeve.

### TECHNICAL FIELD OF THE INVENTION

The present invention relates in general to the suspension and shock absorption of any automotive vehicle.

It relates more particularly to a device for adjusting the stiffness of an automotive vehicle suspension, comprising:
a blocking sleeve which delimits a helical groove for accepting one end of a spring of the suspension, and
an adjusting ring mounted with the ability to rotate with respect to the blocking sleeve about a main axis.

It also relates to a suspension and shock absorber system for an automotive vehicle, comprising an adjusting device as aforementioned.

The invention finds a particularly advantageous application in motor cars, motorbikes, motor coaches and trucks.

### PRIOR ART

A motor car is always fitted, at each of its wheels, with a suspension and shock absorber system.

The suspension part is generally formed of a helical spring operating in compression, while the shock absorber takes the form of a piston-cylinder damper.

The helical suspension spring is selected on the basis of its stiffness, and this selection represents a compromise between roadholding (which requires high stiffness) and comfort (which requires lower stiffness).

In order to partially circumvent this compromise, it is known practice for a suspension to be fitted with an adjusting device that enables the stiffness of the helical spring to be adjusted according to the user requirements (for example whether the user wishes to use their vehicle on the road or on a racetrack).

Such an adjusting device is described for example in document U.S. Pat. No. 8,029,002. The solution presented therein proposes interposing a suspension spring between, at the bottom, a height-adjustable sleeve and, at the top, a spring cup supported by a shock absorber damper. The adjustable sleeve is in practice housed in a receptacle such that it can slide up and down therein. When the sleeve is in an upper position, the spring is used over the entirety of its length and is preloaded between this sleeve and the spring cup. By contrast, thanks to the particular shape of the spring, when the sleeve is in a lowered position, the spring no longer bears against the sleeve but bears directly against the receptacle such that only part of the spring length is used. This device therefore allows the stiffness of the suspension to be modified.

The disadvantage with this device is its bulk because it requires the use of an adjusting sleeve and of a receptacle around this sleeve.

### PRESENTATION OF THE INVENTION

In order to overcome the aforementioned disadvantage of the prior art, the present invention proposes an adjusting device like that defined in the introduction, wherein the adjusting ring comprises a finger which emerges into the helical groove and which is able to form an end-stop for the end of the suspension spring, and wherein locking means are provided that block the rotational mobility of the adjusting ring relative to the blocking sleeve.

Thus, by virtue of the invention, rotation of the blocking sleeve relative to the adjusting ring allows the finger to move along the helical groove. As a result, the length of the suspension-spring coil engaged in the groove can vary, thereby making it possible to modify the working length of the suspension spring (the length situated outside of the groove) and therefore the stiffness of the suspension.

This solution proves to be fairly compact, robust, simple to manufacture and inexpensive.

Other advantageous and non-limiting features of the adjusting device according to the invention, taken individually or in any technically possible combinations, are as follows:
the adjusting ring comprises a flange on which a bearing face of the blocking sleeve rests;
the finger projects upwardly from the flange;
the helical groove has, over at least part of its length, a slot which opens onto said bearing face and through which the finger passes;
the locking means are designed to lock the adjusting ring in a finite number of angular positions with respect to the blocking sleeve;
said finite number is comprised between two and four, endpoints included;
at least one insertion hole is provided in the blocking sleeve, the hole being designed to accept a lever for maneuvering the adjusting ring relative to the blocking sleeve;
the locking means are formed by a protrusion that projects from said flange or, respectively, from said bearing face and that is able to engage in one or another of a number of cavities recessed into said bearing face or, respectively, into said flange;
the adjusting ring has an interior face which is tapped and designed to be screwed onto a damper;
the adjusting ring is slidably mounted on a damper and there is provided a nut which is screwed onto the damper on the opposite side of the adjusting ring from the spring;
there is provided a lock-nut which is designed to be screwed onto the damper on the opposite side of the adjusting ring from the spring.

The invention also relates to a suspension and shock absorber system for an automotive vehicle, comprising:
a damper which comprises a cylinder, a piston and a piston rod which is connected to the piston and which projects out of the cylinder,
a spring passed over the damper, and
an adjusting device as aforementioned, placed at one end of said spring.

Of course, the various features, variants and embodiments of the invention can be combined with one another in various combinations, provided that they are not incompatible with one another or mutually exclusive.

### DETAILED DESCRIPTION OF THE INVENTION

The description that follows with reference to the appended drawings, which are given by way of non-limiting example, will make it easy to understand of what the invention consists and how it may be implemented.

In the appended drawings:

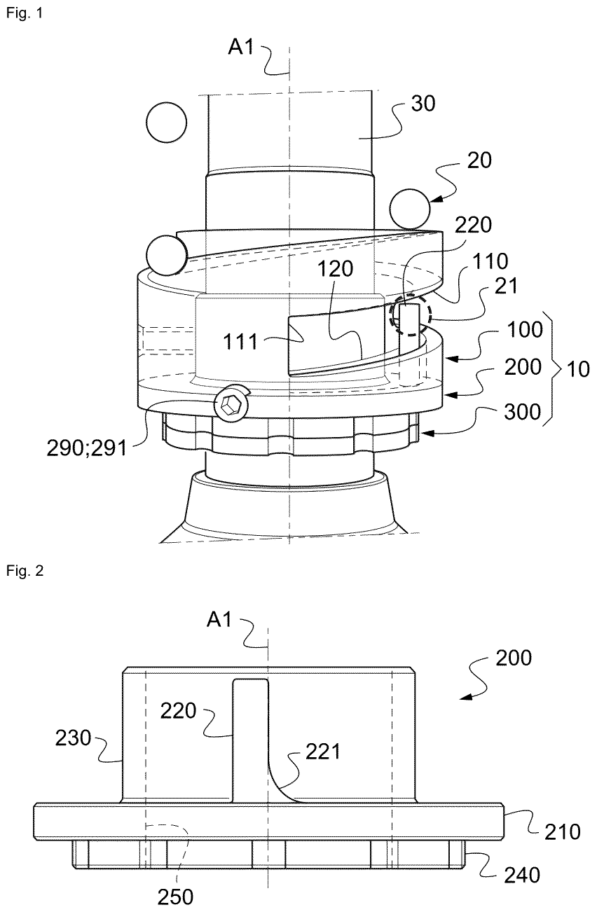

FIG. 1 is a schematic perspective view of part of a suspension and shock absorber system comprising an adjusting device according to the invention;

FIG. 2 is a side view of the adjusting ring of the adjusting device of FIG. 1;

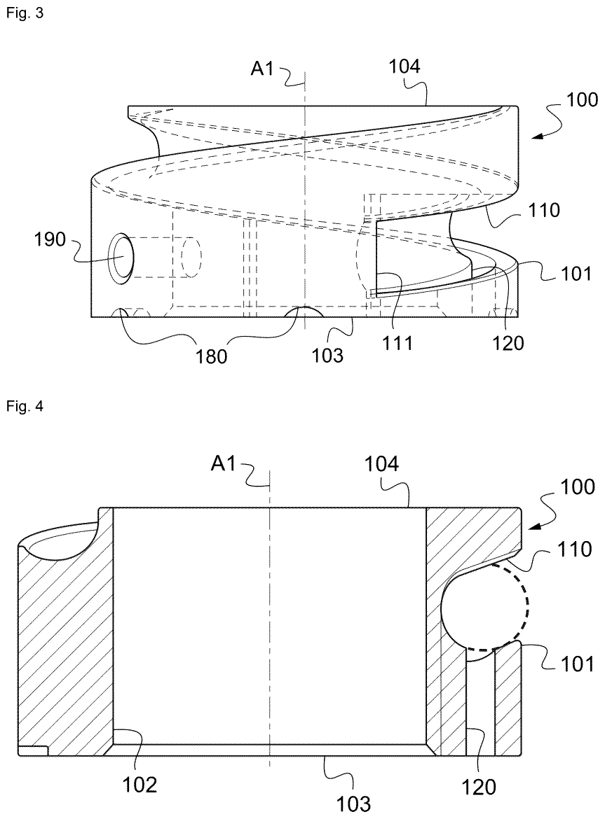

FIG. 3 is a side view of the blocking sleeve of the adjusting device of FIG. 1;

FIG. 4 is a view in longitudinal section of the blocking sleeve of FIG. 3;

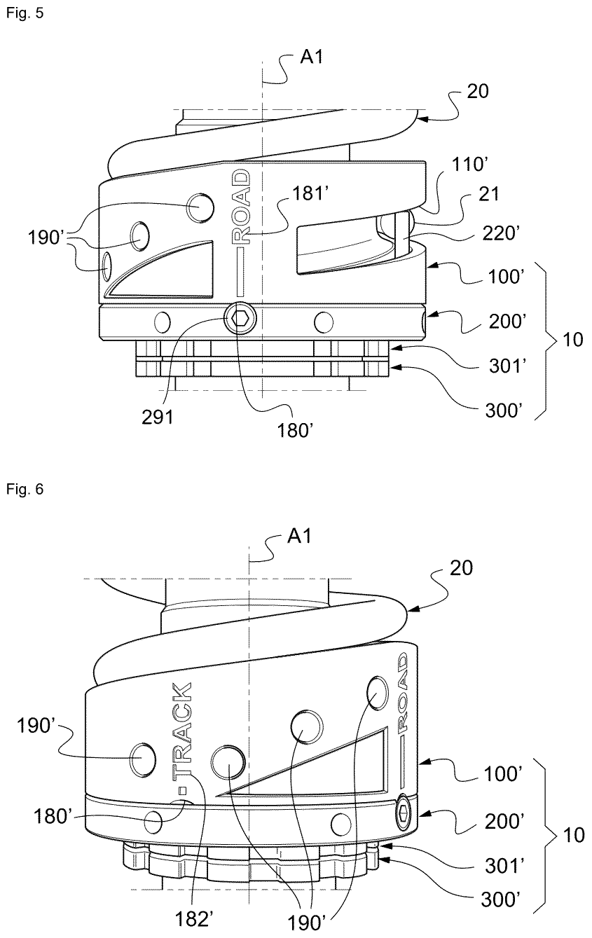

FIG. 5 is a schematic perspective view of an embodiment variant of the adjusting device of FIG. 1, in a first configuration;

FIG. 6 is a schematic view of the adjusting device of FIG. 5, in a second configuration.

FIG. 1 depicts part of a suspension and shock absorber system for an automotive vehicle. In the conventional way, the shock-absorbing part of this system comprises a damper 30 which comprises a cylinder, a piston (not visible) designed to slide inside the cylinder, and a piston rod (not depicted) which is connected to the piston and part of which projects out of the cylinder.

The suspension part of the system itself comprises a multiple-coil helical spring 20.

This spring may adopt various shapes, notably having a diameter and a pitch that are variable. However, in this instance, its diameter will be considered to be constant over its entire length, and the distance between two coils (the pitch) will also be considered to be constant, notably near the bottom end of this helical spring 20.

Regarding this aspect, and for the clarity of the description, it will be considered here that the suspension and shock absorber system is oriented as depicted in FIG. 1, with its damper 30 extending vertically and the piston rod projecting upward from the cylinder part of the damper. The term “lower” will therefore be used to refer to that side of an element that faces toward the road, while the term “upper” will be used to refer to the opposite side. The suspension spring 20 is passed over the damper 30 so that it extends along the same axis thereas. This axis will be referred to hereinafter as “main axis A1”.

It is interposed between, above it, a spring cup (not visible) fixed to the piston rod of the damper and, below it, an adjusting device 10 which more specifically here forms the subject of the present invention and which is secured to the cylinder part of the damper 30.

This adjusting device 10 is intended to allow the stiffness of the suspension to be varied manually.

To this end, it comprises at least two distinct parts, namely a blocking sleeve 100 which accepts and houses the lower end 21 of the spring 20, and an adjusting ring 200 which is mounted with the ability to rotate with respect to the blocking sleeve 100 so that it can vary the length of spring housed in the blocking sleeve 100.

In FIG. 1, the blocking sleeve 100 is depicted such as to show hidden detail, in order to make the invention easier to understand. It is depicted more specifically in FIGS. 3 and 4. It comprises a tubular body 101 which has a lower face 103 and an upper face 104 which are planar and orthogonal to the main axis A1. The lower face 102 of this tubular body 101 is a cylinder of revolution about the main axis A1. Its exterior face is itself substantially a cylinder of revolution about the main axis A1, except that it has a helical groove 110 recessed into part of it.

The tubular body 101 has a radial thickness (measured between its interior and exterior faces) which is preferably greater than the “wire diameter” of the spring 20.

It has a height (measured along the main axis A1) that is preferably greater than the height of one coil of the spring 20.

The helical groove 110 recessed into the tubular body 101 is intended to accept part of the lowermost coil of this spring 20.

To this end, one of its ends opens onto the upper face 104 of the tubular body 101. Its other end, on the other hand, is closed by a closed end wall 111, such that it does not open onto the lower face 103 of the tubular body 101.

The helical groove 110 is recessed into the exterior face of the tubular body 101 and extends such that it opens also to the outside of the tubular body 101. In a variant, provision could be made for the tubular body to be thicker and for the helical groove to be “recessed” completely within the thickness of this body so as not to be accessible from the outside. This variant is non-preferred on account of its bulk and of the risk of the helical groove becoming filled with dust and stone chippings.

The helical groove 110 has a pitch equal to that of the coils of the spring 20. It also has a cross section in the shape of an arc of a circle of a diameter equal, give or take clearances, to the wire diameter of the spring 20. Thus, the lower end 21 of this spring can easily slide in this groove when the spring 20 is turned relative to the tubular body 101. The clearance provided here is greater than 1% of the wire diameter of the spring.

The cross section of this helical groove 110 extends over more than a semicircle such that it forms an adequate seat for the spring 20.

By virtue of this shape, the spring 20 adequately espouses the shape of the helical groove 110 so that load is properly distributed across the entirety of the blocking sleeve 100 when the spring is compressed.

It may be emphasised here, and for a reason that will be understood from reading the next part of this explanation, that the tubular body 101 of the blocking sleeve 100 has a slot 120 which extends from the lower face 103 of the tubular body 101 into the helical groove 110. This slot 120 may be qualified as straight in that it extends vertically from the helical groove 110 as far as the lower face 103 of the tubular body 101. It may also be qualified as curved in that it extends in the continuation of the helical groove 110, underneath same, over a determined angular sector.

It extends over an angular sector about the main axis A1 which is strictly less than 360 degrees and which here is of the order of 180 degrees.

The slot 120 has a width (measured radially relative to the main axis A1) which is strictly less than the wire diameter of the spring 20 and which is approximately equal to one third of this diameter.

As shown in FIG. 3, the lower face 103 of the tubular body 101 is substantially planar so that it can bear directly against the adjusting ring 200.

This adjusting ring 200 is more specifically depicted in FIG. 2.

It chiefly comprises a tube 230 which is a cylinder of revolution about the main axis A1, a flange 210 that borders the tube 230 along the lower end thereof, and a finger 220 which projects upward from the flange 210, some distance away from the tube 230, parallel to the main axis A1.

The tube 230 has an interior face 250 which is tapped so that it can be screwed onto a screw thread provided on part of the height of the cylinder part of the damper 30.

It has an outside diameter that is equal, give or take clearances, to the inside diameter of the tubular body 101 of the blocking sleeve 100.

This blocking sleeve 100 is thus engaged over this tube 230, which tube guides the rotation of the sleeve about the main axis A1.

The flange 210 has an upper face that is planar and orthogonal to the main axis A1 and on which the lower face 103 of the tubular body 101 of the blocking sleeve 100 rests. Thus, this flange 210 acts as a support for the blocking sleeve 100 when the spring is compressed between said sleeve and the spring cup.

The flange 210 has an outside diameter substantially equal to that of the tubular body 101, so that the external faces of these extend in the continuation of one another. The system therefore remains fairly compact.

The finger 220 has a cross section (in a plane orthogonal to the main axis A1) that is substantially rectangular in shape. Its cross section is such that it can be engaged through the slot 120.

It extends height-wise over a length at least equal to half the pitch of the spring 20. This length is such that the finger 220 emerges into the helical groove 110. As shown in FIG. 1, thanks to this arrangement, the finger 220 forms an end-stop against which the lower end 21 of the spring 20 bears.

To strengthen the connection between the finger 220 and the flange 210, a kind of fillet 221 is provided where these two elements meet, this fillet being situated on the side of the finger 220 against which the lower end 21 of the spring 20 bears.

As shown in FIG. 1, when the adjusting ring 200 is turned relative to the blocking sleeve 100, the finger 220 travels along the helical groove 110. The ends of the slot 120 therefore form end-stops for the finger, thereby limiting the angular travel available to the finger to approximately 180 degrees.

By turning the adjusting ring in the clockwise direction (as viewed from above), the finger 220 moves toward the closed end wall 111 of the helical groove 110, so that the spring 20 has more groove length available in which to engage.

By contrast, by turning the adjusting ring in the counterclockwise direction (as viewed from above), the finger 220 moves away from the closed end wall 111 of the helical groove 110, so that the spring 20 has less groove length available in which to engage.

The length of spring 20 engaged in the helical groove 110 may be considered to be inactive inasmuch as it does not participate in the suspension of the vehicle (over this length, the spring is unable to be compressed). Only the length of the spring 20 situated outside of this groove will be active. Thus, moving the finger 220 makes it possible to vary the stiffness of the suspension.

When the spring 20 is under load, the friction forces prevent the adjusting ring 200 from being able to be turned easily relative to the blocking sleeve 100.

Hence, as shown in FIG. 3, the tubular body 101 of the blocking sleeve 100 comprises at least one hole 190 which extends radially with respect to the main axis A1 and in which it is possible to engage a rod. This rod can then be used as a lever in order to turn the blocking sleeve 100 about the main axis A1.

It will also be noted, with reference to FIGS. 1 and 2, that the adjusting ring 200 comprises a part 240 that makes it easier to maneuver. This part is formed of a washer 240 which is situated underneath the flange 210 and has notches recessed into its peripheral edge. This washer 240 therefore allows the entirety of the adjusting ring 200 to be turned using a pin wrench in order to cause it to move up or down along the cylinder part of the damper 30 (in order to adjust the preload on the spring 20).

In operation, if the adjusting ring 200 were left free to rotate with respect to the blocking sleeve 100, there would be a risk of the spring 20 pushing the finger 220 back toward the closed end wall 111 of the helical groove 110.

In order to avoid that, locking means 290 are provided that block the rotational mobility of the adjusting ring 200 relative to the blocking sleeve 100.

These locking means 290 are designed here so that the adjusting ring 200 can be locked in only a finite number of angular positions with respect to the blocking sleeve 100.

As a preference, this finite number is comprised between two and five, endpoints included. In the embodiment depicted in FIGS. 1 to 4, provision is made for the adjusting ring 200 to be able to adopt one or another of just three angular positions with respect to the blocking sleeve 100.

As is clearly shown in FIG. 1, these locking means 290 for this purpose comprises a screw which is screwed radially into a tapped bore made in the peripheral edge of the flange 210 of the adjusting ring 200. This screw has a head 291 which, when the screw is screwed into the tapped bore, becomes housed in a cutout provided in the flange.

This screw head 291 is a socket head, in this instance having a hexagonal socket, for ease of screwing. The screw head has a diameter greater than the thickness of the flange 210, so that it overhangs this flange at the front and rear.

The blocking sleeve 100 accordingly has three notches 180 (see FIG. 3) recessed into its lower face 103, and in each of which the head 291 of the screw can become housed.

These notches 180 are arc-shaped, circumscribing a cylinder of diameter approximately equal to that of the screw head, and extending over less than 180 degrees.

Here, these notches 180 are angularly separated from one another by around 80 or 90 degrees about the main axis A1.

Thus, when the user wishes to modify the angular position of the adjusting ring 200 with respect to the blocking sleeve 100, they may partially unscrew the screw, turn these two components relative to one another until the screw head 291 is once more aligned with one notch 180, and then re-tighten the screw.

However, if the user has the assistance of a lever arm, there is no need for them to unscrew the screw: they may effectively force the adjusting ring 200 to turn relative to the blocking sleeve 100. It will therefore be appreciated that, as a variant, the screw could be replaced by a simple bulge formed as one with the adjusting ring 200 and projecting from the flange. In another variant, this bulge could be provided on the tubular body 101 and the notches (180) could be recessed into the flange 210.

As has been explained above, the tube 230 of the adjusting ring 200 is screwed onto the cylinder part of the damper 30. It is thus possible, by turning it for example by a full turn, to modify the preload of the suspension.

It will thus be noted that, in the embodiment illustrated in FIGS. 1 to 4, the stiffness of the spring 20 is adjusted by turning the blocking sleeve 100 about the cylinder part of the damper 30, without modifying the angular position of the adjusting ring 200, thereby making it possible to act only on the stiffness of the suspension but not on the preload thereof or on the suspension height of the vehicle bodyshell. Thus, the adjustments are independent of each other.

In order to prevent the adjusting ring 200 from becoming unscrewed during use, a lock-nut 300 is provided here, screwed onto the cylinder part of the damper 30 underneath the adjusting ring 200. Here, this lock-nut has a shape identical to that of the washer 240 of the adjusting ring 200. It can therefore be tightened using the same pin wrench.

It will be noted that the adjusting ring 200 here is produced as one piece in a metallic material, in this instance aluminum (so as to limit its weight).

The locking sleeve 100 is itself made from a softer material than the adjusting ring 200, namely in this instance a plastics material. It could be produced as a single piece from a fiber-reinforced plastics material, or from a sufficiently rigid plastics materials such as Ertalon®.

The present invention is in no way limited to the embodiment that has been described and shown, but a person skilled in the art will know how to add thereto any variant according to the invention.

Thus, for example, it would be possible to envision for the blocking sleeve 100 not to bear directly on the adjusting ring 200 but for an element such as a washer to be interposed between these.

An embodiment variant of the adjusting device 10 is depicted in FIGS. 5 and 6.

This variant is consistent with the embodiment described with reference to FIGS. 1 to 4 in as much as, in this variant, the device here again comprises a blocking sleeve 100′ which delimits a helical groove 110′, and an adjusting ring 200′ which comprises a finger 220′ engaged in the helical groove 110′ and which is mounted so that it can be turned relative to the blocking sleeve 100′.

The main difference is that, in this variant, the adjusting ring 200′ is slidably mounted on the cylinder part of the damper. It therefore has no internal tapping. As a result, the turning of this ring does not lead to a modification to the preload of the spring 20 (or to the suspension height of the vehicle bodyshell).

In order to be able to adjust this preload, the adjusting device 10 comprises a nut 301′ which is positioned underneath this adjusting ring 200′. For the same reasons mentioned previously, a lock-nut 300′ is also provided underneath this nut 301′. In this instance, this nut and this lock-nut are identical.

A second difference is that only two notches 180′ are provided in the blocking sleeve 100′, such that the latter can have just two stable angular positions relative to the adjusting sleeve 200′ (these here being separated by approximately 80 degrees).

This restricted number of angular positions prevents the user from making mistakes in adjusting the various adjusting devices 10 with which their vehicle is equipped: it would in fact be dangerous for one of the four adjusting devices 10 with which their vehicle is equipped to be adjusted to a different setting than the others.

With the same objective of avoiding any adjustment mistakes, provision is furthermore made here for the adjusting device 10 to comprise markings 181′, 182′ indicating which configuration it is in.

Thus, a marking 181′ stating “road” is provided next to one of the notches 180′, and a marking 182′ stating “track” is provided next to the other of the notches ‘180’. As a preference, these markings are in different colors.

In this way, the user can quickly check which configuration the adjusting device 10 is in, by looking to see which marking the screw head 291 is aligned with.

Also preferentially, just one of these markings 181′, 182′ (the one with which the screw head 291 is aligned) is visible from outside the vehicle when the vehicle is assembled. It is thus possible, when the vehicle is ready to set out, to check that the adjusting devices 10 are all in the same configuration.

Advantageously, it is possible to turn the blocking sleeve 100′ with respect to the adjusting ring 200′ only if the corresponding wheel of the vehicle is removed, such that the changing of the configuration of the adjusting device 10 is perceived as a significant action that affects the stability of the vehicle. To that end, the lever-insertion holes 190′ are positioned accordingly.

In this embodiment variant, in order to make it easier to adjust the angular position of the blocking sleeve 100′ with respect to the adjusting ring 200′, several radial holes 190′ angularly distributed about the main axis A1 are provided, so that the lever can be engaged in one of the holes and then in another for maneuvering the device in a tight and somewhat inaccessible space.

1-10. (canceled)

11. An adjusting device for adjusting a stiffness of an automotive vehicle suspension, comprising:
a blocking sleeve which delimits a helical groove for accepting one end of a spring of said suspension; and
an adjusting ring mounted with the ability to rotate with respect to the blocking sleeve about a main axis,
wherein the adjusting ring comprises a finger which emerges into the helical groove and which is able to form an end-stop for the end of said spring, and
wherein locking means are provided that block the rotational mobility of the adjusting ring relative to the blocking sleeve.

12. The adjusting device as claimed in claim 11, wherein the adjusting ring comprises a flange on which a bearing face of the blocking sleeve bears and wherein the finger projects upwardly from the flange.

13. The adjusting device as claimed in claim 12, wherein the helical groove has, over at least part of its length, a slot which opens onto said bearing face and through which the finger passes.

14. The adjusting device as claimed in claim 11, wherein the locking means are configured to lock the adjusting ring in a finite number of angular positions with respect to the blocking sleeve.

15. The adjusting device as claimed in claim 11, wherein the locking means are configured to lock the adjusting ring in between two and four angular positions, endpoints included, with respect to the blocking sleeve.

16. The adjusting device as claimed in claim 11, wherein at least one insertion hole is provided in the blocking sleeve, the hole being configured to accept a lever for maneuvering the adjusting ring relative to the blocking sleeve.

17. The adjusting device as claimed in claim 11, wherein the adjusting ring comprises a flange on which a bearing face of the blocking sleeve rests and wherein the locking means are formed by a protrusion that projects from said flange or, respectively, from said bearing face and that is configured to engage in one or another of a number of cavities recessed into said bearing face or, respectively, into said flange.

18. The adjusting device as claimed in claim 11, wherein the adjusting ring has an interior face which is tapped and configured to be screwed onto a damper.

19. The adjusting device as claimed in claim 18, further comprising a lock-nut configured to be screwed onto the damper on the opposite side of the adjusting ring from the spring.

20. The adjusting device as claimed in claim 11, wherein the adjusting ring is slidably mounted on a damper and wherein a nut is screwed onto the damper on an opposite side of the adjusting ring from the spring.

21. A suspension and shock absorber system for an automotive vehicle, comprising:
a damper which comprises a cylinder, a piston, and a piston rod which is connected to the piston and which projects out of the cylinder;
a spring passed over the damper, and
the adjusting device as claimed in claim 11 placed at one end of said spring.
